(19) United States
(12) Patent Application Publication
(10) Pub. No.: US 2015/0329030 A1
(43) Pub. Date: Nov. 19, 2015

(54) VEHICLE SEAT FOR A MOTOR VEHICLE

(71) Applicant: GM GLOBAL TECHNOLOGY OPERATIONS LLC, Detroit, MI (US)

(72) Inventors: Joerg WIEGELMANN, Bodenheim (DE); Juergen NILLIUS, Ginsheim- Gustavsburg (DE)

(73) Assignee: GM GLOBAL TECHNOLOGY OPERATIONS LLC, Detroit, MI (US)

(21) Appl. No.: 14/711,349

(22) Filed: May 13, 2015

(30) Foreign Application Priority Data
May 14, 2014 (DE) 102014007149.9

(51) Int. Cl. B60N 2/58; B60N 2/70; B60N 2/64

(52) U.S. Cl. CPC B60N 2/5858; B60N 2/64; B60N 2/70

(57) ABSTRACT

A vehicle seat for a motor vehicle is disclosed which includes a seat part having a seat cushion, a seat cover and a fastening device for fixing the seat cover to the seat part. The vehicle seat also includes a back part with a seat cushion, a seat cover and a fastening device for fixing the seat cover to the seat back. The seat cover includes an upholstery portion and an elastic element to avoid major tensile forces on the upholstery portion and a permanent elongation of the seat cover resulting from a seated occupant.

### CROSS-REFERENCE TO RELATED APPLICATION

This application claims priority to German Patent Application No. 102014007149.9, filed May 15, 2014, which is incorporated herein by reference in its entirety.

### TECHNICAL FIELD

This present disclosure pertains to a vehicle seat for a motor vehicle, and more particularly to a seat assembly having a seat, a seat cushion and a seat cover with a fastening element securing the seat cover to the vehicle seat.

### BACKGROUND

Vehicle seats for motor vehicles typically include a seat part and a back part. The seat and back part includes a seat center and two lateral or side seat bolsters respectively. The seat bolsters serve to provide adequate lateral support of occupants on the vehicle seat during lateral accelerations of the motor vehicle when the vehicle seat is used in the motor vehicle. Under a seat cover, the seat part and the back part include seat cushion or padding fastened to a stiff seat shell. The seat cover on the seat center is generally fixed in transverse direction of the vehicle seat by two retaining strips running in longitudinal direction and in the process the seat covering is also pre-tensioned. When a person sits on the vehicle seat, in particular on the seat center, elastic deformation of the seat cushion occurs and because of this also a stretching of the seat cover. When using a seat cover made of leather, major tensile forces occur on the seat cover made of leather since the seat cover made of leather has only very minor elastic properties, i.e. a relatively high modulus of elasticity. Because of these tensile forces on the seat cover made of leather, which may be significant while someone sits on the vehicle seat, elongation of the seat cover made of leather occurs during the long-term and continuous utilization of the vehicle seat. This leads to creases or bulges forming on the seat cover made of leather when no person is seated on the vehicle seat. This is visually undesirable since such of creases or bulges leaves a negative visual impression.

DE 101 30 250 C2 discloses a profile strip for tacking a covering to a cushion or padding, in particular to a seat cushion for a seat for a motor vehicle is known. The profile strip has a T-shaped cross section and is arranged on a tacking channel.

### SUMMARY

The present disclosure provides a vehicle seat for a motor vehicle having a seat cover, e.g., a seat cover made of leather, which minimizes or eliminates the creases and/or bulges formed on the seat cover even during long-term and continuous utilization of the vehicle seat. The vehicle seat includes a seat part with a seat cushion or padding, a seat cover for the seat and at least one fastening device for fixing the cover. The vehicle seat also includes a back part with a seat back cushion or padding, a cover for the seat back (also referred to as the seat cover) and at least one fastening device for fixing the cover. An elastic element is connected to the seat cover in order to avoid major tensile forces on the seat cover and elongation of the seat cover resulting from long-term and continuous utilization of the vehicle seat. When a person sits on the vehicle seat, elastic stretching and thus a tensile force occurs on the seat cover since the seat cushion is deformed accordingly. The seat cover is fastened to the at least one fastening device, and preferably two fastening devices, so that position change of the seat cover is minimized at the end regions at which the seat cover is fastened to the fastening devices. The elastic element functions so that the required increase in length of the seat cover between two fastening devices can be substantially realized by elastic stretching of the elastic element. In this way, substantially no elastic stretching of the seat cover is required while a person sits on the vehicle seat and the tensile forces occurring on the seat cover are only slightly larger while a person sits on the vehicle seat than without a person sitting on the vehicle seat. Because of the substantially continuously constant tensile forces on the seat cover, independently of whether a person sits on the vehicle seat or not, substantially no elongation of the seat cover occurs on the seat cover since substantially no elastic stretching of the seat cover is required. When nobody sits on the vehicle seat, elastic shape restoration substantially of the elastic element occurs, i.e. the length of the seat cover and of the elastic element, for example in transverse direction, is reduced.

In an embodiment, the elastic element is formed strip or band-like as an elastic stretching strip or an elastic stretching band. The elastic element is thus formed as a strip or band similar to the fastening device. The entire region of the fixing of the seat cover on the fastening device can be suitably elastically stretched with the elastic element.

In a further embodiment, the elastic element is formed from an elastic fabric and/or from rubber and/or the elastic element is formed from a material other than the seat cover and/or the elastic element is formed from a material other than the fastening device. The modulus of elasticity of the seat cover is preferably in the range of two to twenty times greater than the modulus of elasticity of the elastic element. Because of the low modulus elasticity of the elastic element compared to the seat cover, the elastic elongation of the seat cover with the elastic element is substantially performed by the elastic element when tensile forces occur on the seat cover. As a result of the low modulus of elasticity of the elastic element, minimal tensile forces thus also occur on the seat cover while a person sits on the vehicle seat, and the forming of bulges or creases resulting stretching of the seat cover can be advantageously avoided.

In an embodiment, the fastening device is formed as a retaining strip. In a version, the length of the elastic element, which is fastened to the fastening device, in particular the retaining strip substantially corresponds to the length of this fastening device, in particular the retaining strip. The length of the elastic element thus corresponds to the length of the fastening device with a deviation in the range of 30% to 3% or less. Accordingly, the required change in length of the seat cover and of the elastic element along the entire length of the fastening device with the elastic element can be substantially performed by the elastic element. Practically, the fastening device and/or the elastic element are at least partially arranged within a trim channel. The fastening device and the elastic element are thus only partially visible from the exterior surface of the vehicle seat.

In a further embodiment, the trim channel is formed on the seat cushion. The seat cushion includes a corresponding groove which forms the trim channel. The elastic element rests on the fastening device and is preferably guided about the fastening device, i.e. forming of the elastic element on the fastening device occurs. An end of the elastic element in this case is connected or fixed to the fastening device and another end of the elastic element is connected or fixed to the seat cover, in particular with a seam connection.

In a further configuration, the elastic element is connected to the seat cover and/or the fastening element with a positively joined connection, in particular a seam connection. A seam connection can be produced particularly reliably and accordingly has durable strength during the operation of the motor vehicle.

In an embodiment, the seat part includes a seat center and two side seat bolsters and/or the back part includes a seat center and two lateral bolsters. The seat cover on the seat center of the seat part is fastened to two fastening devices and an elastic element each is fastened to a fastening device or both fastening devices and/or the seat cover is fastened to the seat center of the back part on two fastening devices and an elastic element each is fastened to a fastening device or both fastening devices. The elastic seat cushion may be formed from foam material. The seat cover may be formed from leather or fabric. In particular, in the case of a seat cover made of leather, forming of dents or creases of the leather can be avoided with the elastic element since leather has relative low elastic properties and as a consequence thereof particularly large tensile forces occur on the leather while a person sits on the vehicle seat in order to obtain the required stretching of the seat cover made of leather and resulting from this a continuous elongation of the leather would occur which however can be avoided with the elastic element.

The present disclosure also includes a motor vehicle with at least one vehicle seat, wherein the at least one vehicle seat as further described herein.

### BRIEF DESCRIPTION OF THE DRAWINGS

The present disclosure will hereinafter be described in conjunction with the following drawing figures, wherein like numerals denote like elements.

FIG. 1 illustrates a longitudinal section of a vehicle seat;

FIG. 2 illustrates a cross section A-A according to FIG. 1 of a seat part of the vehicle seat without loading of the seat part;

FIG. 3 illustrates a cross section A-A according to FIG. 1 of the seat part of the vehicle seat with loading of the seat part; and

FIG. 4 illustrates a lateral view of a motor vehicle.

### DETAILED DESCRIPTION

The following detailed description is merely exemplary in nature and not intended to limit the present disclosure or the application and the uses of the present disclosure. Furthermore, there is no intention to be bound by any theory presented in the preceding background of the present disclosure or the following detailed description.

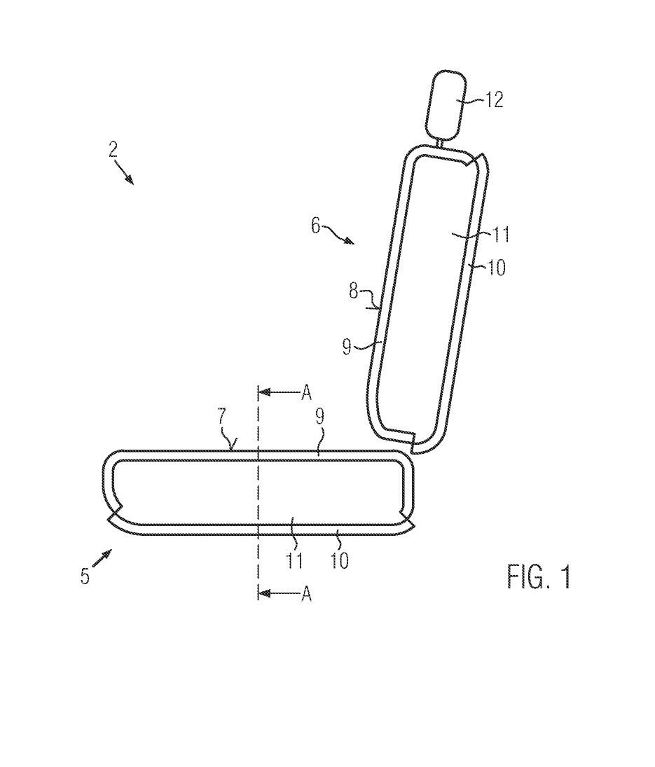

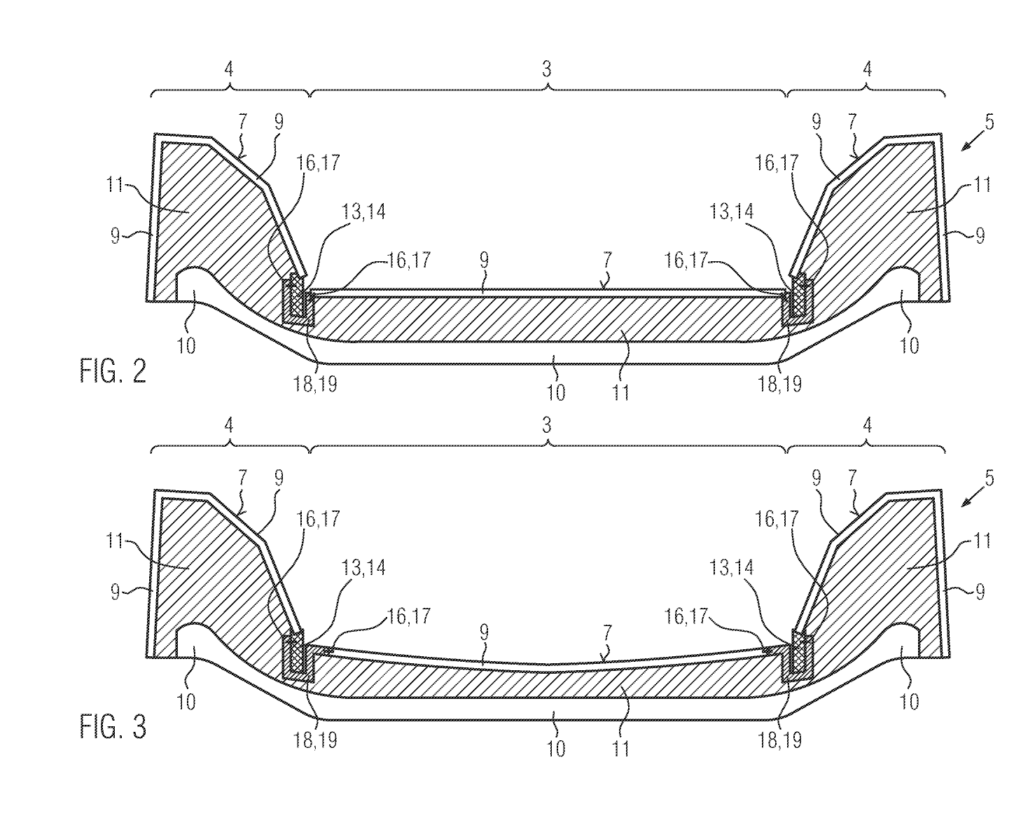

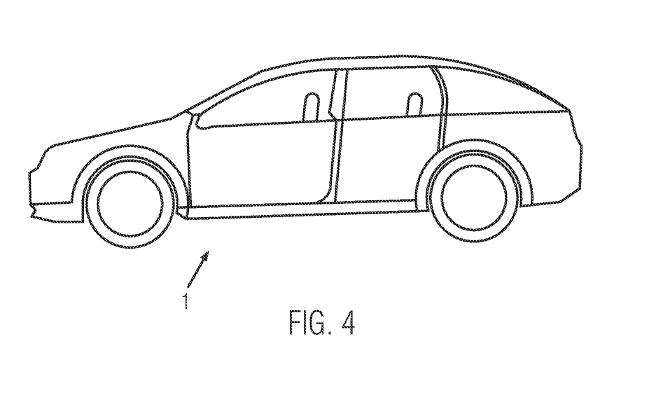

With reference to the figures, a motor vehicle 1 (FIG. 4) includes an internal combustion engine and/or an electric motor for driving the motor vehicle 1. Vehicle seats 2 are arranged within an interior space, which is substantially bounded by a body of the motor vehicle 1. Here, the motor vehicle 1 includes two front seats as vehicle seats 2 and three back seats as vehicle seats 2. The three back seats as vehicle seats 2 may form a rear seat bench. The vehicle seat 2 includes a seat bottom 5 and a seat back 6 (FIG. 1). On a seat surface 7 of the seat bottom 5, the seat bottom 5 includes a upholstery portion 9 made of leather and the seat back 6 likewise includes the upholstery portion 9 on a back surface 8. Between the upholstery portion 9 and a seat shell 10, a seat cushion or padding 11 of foam material is arranged. Analogously to this, the seat back 6 includes a seat cushion or padding 11. The seat cushion 11 is elastic such that the seat and back surfaces 7, 8 are each elastically deformable when pressure forces are applied. A seat shell 10 as a plastic shell serves as static support part for the seat bottom 5 and the seat back 6. On the upper end region of the seat back 6 a headrest 12 is additionally arranged. The seat and parts 5, 6 each include a seat center 3 and two side bolsters 4. The seat surface 7 of the seat bottom 5 on the side bolsters 4 is elevated with respect to the seat center 3 (FIGS. 2 and 3). This applies analogously to the seat surface 7 of the seat back 6. The side seat bolsters 4 serve in order to be able to hold a person on the vehicle seat 2 during lateral accelerations of the motor vehicle 1.

In FIGS. 2 and 3, a cross section of the seat bottom 5 is shown. On the seat cushion 11, two grooves aligned in longitudinal direction are formed, which form a trim channel 15. Within the trim channel 15, a retaining strip 14 is arranged as a fastening device 13. The seat cover 7 for the seat center 3 includes an upholstery portion 9 and an elastic element 18, 19. The seat cover 7 for the side bolsters 4 includes an upholstery portion 9 and a retaining strip 13, 14. The upholstery portion 9 on the seat center 3 is indirectly fastened to the retaining strip 14 by a strip or strip-like band 18, 19 of elastic fabric or rubber. To this end, an end of the elastic element 18, 19 is fastened to the retaining strip 14 on the outside on an upper end region by a positively joined connection 16 as a seam connection 17 and another end of the elastic element 18, 19 is likewise fastened to the seat center 3 by a positively joined connection 16 as a seam connection 17 on an end of the upholstery portion 9. The elastic element 18, 19 in this case is passed about the retaining strip 14. In the shown embodiment, the elastic element 18, 19 is passed about the lower side of the retaining strip 14, which can be formed as a fixed, strip-like element. The term “strip-like” within the scope of the present disclosure refers to an element the thickness of which is less than half the width and the width is less than half of the length. As seen in FIGS. 2 and 3, the width of the retaining strip 14 extends perpendicularly to the seat surface 7, while the length of the retaining strip 14 runs along an outer edge of the seat surface 7 in each case. The elastic element 18, 19 in this case is connected or fastened to the retaining strip 14 below the upper edge of the same. This type of fastening offers an optimal hold for the elastic element 18, 19. Perpendicularly to the plane of FIGS. 2 and 3, i.e. in longitudinal direction of the vehicle seat 2, the length of the holding strip 14 corresponds to the length of the strip-like elastic element 18, 19. In FIG. 2, the seat bottom 5 is shown without a person sitting on the vehicle seat 2. For this reason, no elastic deformation occurs on the seat cushion 11 on the seat center 3. The upholstery portion 9 and the elastic element 18, 19 in this case have a low tensile force in transverse direction of the vehicle seat 2, i.e. the elastic element 18, 19 may be slightly pre-tensioned elastically. When a person sits on the vehicle seat 2, elastic deformation of the seat cushion 11 on the seat bottom 5 occurs (FIG. 3) and as a consequence thereof an increase in length in transverse direction of the seat cover 7 is required. Since the ends of the elastic element 18, 19 are connected with the seam connection 17 to the fixed retaining strip 14 in a fixed manner, stretching of the seat cover 7 occurs principally in the elastic element 18, 19 and not the upholstery portion 9. In particular, the increase in length of the upholstery portion 9 and of the elastic element 18, 19 required in transverse direction is made available because of the high elastic properties of the elastic element 18, 19 substantially by the two elastic elements 18, 19 through elastic stretching such that the tensile forces that occur in transverse direction on the upholstery portion 9 and the two elastic elements 18 while a person sits on the vehicle seat 2 (FIG. 3) are only slightly greater than when no person sits on the vehicle seat 2 (FIG. 2). An upholstery portion 9 made of leather is thus exposed to the substantially same tensile forces in the transverse direction of the vehicle seat 2 while a person sits on the vehicle seat 2 as also when no person sits on the vehicle seat 2. In this way, an upholstery portion 9 made of leather is not exposed to significant tensile forces which might otherwise cause an elongation of the upholstery portion 9 and result in a permanent stretching without elastic return of the upholstery portion 9.

The design structure of the seat bottom 5 shown in FIGS. 2 and 3 with the two retaining strips 14 and the two elastic elements 18, 19 may be equally used in the seat back 6. Considered on the whole, substantial advantages are associated with the vehicle seat 2 according to the present disclosure. The modulus of elasticity of the two elastic elements 18, 19 is substantially lower than the modulus of elasticity of the upholstery portion 9 made of leather or upholstery fabric such that the required length enlargement while a person sits on the vehicle seat 2 is substantially absorbed by an elastic deformation of the two elastic elements 18, 19. In this way, only minor tensile forces in transverse direction of the vehicle seat 2 occur on the seat center 3 on the upholstery portion 9 made of leather or upholstery fabric even while a person sits on the vehicle seat 2, so that because of this lasting elongation of the upholstery portion 9 made of leather can be advantageously avoided. As a result, no bulges or creases on the upholstery portion 9 made of leather or upholstery fabric occur on the vehicle seat 2 upon extended use of the vehicle seat 2 after several years.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A vehicle seat for a motor vehicle comprising:
a seat bottom having a bottom cushion, a seat cover and at least one fastening device for fixing the seat cover; and
a seat back having a back cushion, a seat back cover and at least one fastening device for fixing the seat back cover,
wherein at least one elastic element is connected to the seat cover and configured to minimize tensile forces on and elongation of at least one of the seat cover.

17. The vehicle seat according to claim 16, wherein the elastic element comprises an elastic strip.

18. The vehicle seat according to claim 17, wherein the elastic element is selected from the group consisting of an elastic fabric and a rubber material, wherein the seat cover and the fastening device are of a material other than the elastic element.

19. The vehicle seat according to claim 16, wherein the seat cover comprises a material having a modulus of elasticity which is in the range of two (2) to twenty (20) times greater than a modulus of elasticity of the elastic element.

20. The vehicle seat according to claim 16, wherein the at least one fastening device comprises a retaining strip.

21. The vehicle seat according to claim 16, wherein the at least one fastening device comprises a retaining strip and the length of the elastic element fastened to the retaining strip substantially corresponds to the length of the at least one fastening device.

22. The vehicle seat according to claim 16, wherein the seat bottom further comprising a trim channel, and wherein at least one of the fastening device and the elastic element is at least partially arranged within a trim channel.

23. The vehicle seat according to claim 22, wherein the trim channel is formed in the bottom cushion.

24. The vehicle seat according to claim 16, wherein the elastic element is secured to fastening device with a seam connection.

25. The vehicle seat according to claim 16, wherein the seat bottom further comprises a seat center and a side bolster.

26. The vehicle seat according to claim 25, wherein the seat cover comprises a first portion enveloping the seat center and having the elastic element secured to a lateral edge thereof, a second portion enveloping the side bolster and having the fastening device secured to a lateral edge thereof, and a seam connection between the elastic element and the fastening device.

27. The vehicle seat according to claim 16, wherein the seat cushion comprises an elastic foam material.

28. The vehicle seat according claim 16, wherein the seat cover comprises a leather material.

29. A motor vehicle comprising at least one vehicle seat according to claim 16.

30. A vehicle seat for a motor vehicle comprising:
a seat part having a shell supporting a cushion; and
a cover enveloping the cushion and including a first portion having a retaining strip secured along an first edge thereof and a second portion having an elastic element secured along a second edge thereof, wherein the elastic element is secured to the retaining strip at a seam connection and is configured to minimize tensile forces on and elongation of at least one of the first and second portions of the cover.

31. The vehicle seat according to claim 30 further comprises a trim channel formed in the cushion, wherein at least one of the retaining strip and the elastic element is at least partially arranged within the trim channel.

32. The vehicle seat according to claim 30, wherein the cushion comprises a side bolster and a center portion, wherein the first portion of the cover envelopes the side bolster and the second portion of the cover envelopes the center portion.

33. The vehicle seat according to claim 30, wherein the cover comprises a material having a modulus of elasticity which is in the range of two (2) to twenty (20) times greater than a modulus of elasticity of the elastic element.

34. The vehicle seat according to claim 30, wherein the seat part comprises a seat bottom.

35. The vehicle seat according to claim 30, wherein the seat part comprises a seat back.
